(19) United States
(12) Patent Application Publication
(10) Pub. No.: US 2025/0108288 A1
(43) Pub. Date: Apr. 3, 2025

(54) SYSTEM AND METHOD FOR TREASURE HUNTING GAME

(71) Applicant: Treasure Games, LLC, Great Falls, MT (US)

(72) Inventor: Dirk D. Gibson, Great Falls, MT (US)

(73) Assignee: Treasure Games, LLC, Great Falls, MT (US)

(21) Appl. No.: 18/978,780

(22) Filed: Dec. 12, 2024

Related U.S. Application Data
(63) Continuation of application No. PCT/US2023/068476, filed on Jun. 15, 2023.
(60) Provisional application No. 63/491,345, filed on Mar. 21, 2023.
(60) Provisional application No. 63/352,742, filed on Jun. 16, 2022.

(51) Int. Cl. A63F 13/216; A63F 13/35; A63F 13/61

(52) U.S. Cl. CPC A63F 13/216; A63F 13/35; A63F 13/61

(57) ABSTRACT

A method for playing a location-based game. The method includes hiding at least one treasure in the real world and hosting a virtual and real world treasure hunting game wherein players hunt for the at least one treasure in the real world. The method also includes generating an in-game solvable element that is solvable by the players and which aids the players in finding the at least one treasure upon being solved. The method also includes integrating the at least one treasure and/or the solvable element with content and/or a location associated with an advertising partner for directly engaging the players with the advertising partner without interrupting a gaming experience. The method also includes finding, by a winning player of the players, the at least one treasure.

### CROSS REFERENCE TO RELATED APPLICATIONS

This present application claims priority to international patent application serial number PCT/US23/68476 entitled “SYSTEM AND METHOD FOR TREASURE HUNTING GAME” filed Jun. 15, 2023, which claims priority to U.S. provisional patent application Ser. No. 63/352,742 entitled the same and filed Jun. 16, 2022, and to U.S. provisional patent application Ser. No. 63/491,345 entitled the same and filed Mar. 21, 2023, which are incorporated herein by reference.

### BACKGROUND

The present disclosure relates to the gaming industry, and more specifically, to location-based games.

Games in various forms have been a part of human life as far back as the oldest discovered petroglyphs, which depicted hand games, games of physical abilities, and strategy games. Now, numerous games incorporate virtual and real-world elements. Such games in the gaming industry are known as location-based games or GPS enabled games.

Some location-based games incorporate real world geography and the physical location of the player to enhance the player's overall gaming experience. Other location-based games key certain items and/or events in the virtual world to a particular location in the real world. Still other location-based games, often referred to as parallel reality games, include a virtual world that parallels the real world.

Typically, advertisements associated with games consist of a name placement in a static image or video which is featured during a break in the game. Such advertisements may reach numerous viewers of the game; however, the effectiveness and retention of these advertisements are typically low because these advertisements are merely viewed as irrelevant content unassociated to the game which the viewer is watching. As technology progresses, advertisements have become more interactive; thus, increasing the effectiveness of the advertisements.

Yet, there still exists a need to improve the gaming and advertising industries.

### SUMMARY

In one exemplary embodiment, there is provided an exemplary embodiment of a computer-based system for implementing a content creation and distribution system for a treasure hunting location-based game. The system may include a network, one or more devices of the players, one or more treasures to be found by the players, a game server, and a multimedia server.

In one exemplary embodiment, there is provided a method for playing a location-based game. The method includes hiding at least one treasure in the real world and hosting, by a game server, a virtual and real world treasure hunting game wherein players hunt for the at least one treasure in the real world. The method also includes generating, by the game server, an in-game solvable element that is solvable by the players and which aids the players in finding the at least one treasure upon being solved. The method also includes integrating the at least one treasure and/or the solvable element with content and/or a location associated with an advertising partner for directly engaging the players with the advertising partner without interrupting a gaming experience. The method also includes prompting, by the game server, at least one device of each player to display the solvable element. The method also includes finding, by a winning player of the players, the at least one treasure.

In one exemplary embodiment, there is provided a computer-implemented method. The method includes hosting a virtual and real world treasure hunting game wherein players hunt for at least one treasure in the real world, obtaining player data from at least one sensor of at least one device of each player, and generating a virtual map of the treasure hunting game which corresponds to the real world. The method further includes generating an in-game solvable element that is solvable by the players and which aids the players in finding the at least one treasure upon being solved. The method further includes generating an in-game advantage element that aids the players in finding the at least one treasure. The method further includes integrating the at least one treasure, the solvable element, and/or the advantage element with content and/or a location associated with an advertising partner for directly engaging the players with the advertising partner without interrupting a gaming experience. The method further includes prompting an interface of the at least one device of each player to display the solvable element and/or the advantage element. The method further includes monitoring the at least one treasure to obtain treasure data from one or more treasure sensors and obtaining winning player data associated with a winning player of the players who found the at least one treasure. The method further includes validating a legitimate finding of the at least one treasure by the winning player by processing and analyzing the player data, the winning player data, and the treasure data.

In one exemplary embodiment, there is provided a system. The system includes a game server, one or more processors, and one or more memories storing executable instructions, wherein the one or more processors are configured to execute the instructions to perform operations. The operations include hosting, by the game server, a virtual and real world treasure hunting game wherein players hunt for at least one treasure in the real world and obtaining player data from at least one sensor of at least one device of each player. The operations further include generating a virtual map of the treasure hunting game which corresponds to the real world, generating an in-game solvable element that is solvable by the players and which aids the players in finding the at least one treasure upon being solved, and generating an in-game advantage element that aids the players in finding the at least one treasure. The operations further include integrating the at least one treasure, the solvable element, and/or the advantage element with content and/or a location associated with an advertising partner for directly engaging the players with the advertising partner without interrupting a gaming experience. The operations further include prompting an interface of the at least one device of each player to display the solvable element and/or the advantage element and monitoring the at least one treasure to obtain treasure data from one or more treasure sensors. The operations further include obtaining winning player data associated with a winning player of the players who found the at least one treasure, and validating a legitimate finding of the at least one treasure by the winning player by processing and analyzing the player data, the winning player data, and the treasure data.

In one exemplary embodiment, there is provided a non-transitory computer-readable storage medium storing executable instructions that, when executed by one or more processors, cause operations which include hosting a virtual and real world treasure hunting game wherein players hunt for at least one treasure in the real world. The operations further include obtaining player data from at least one sensor of at least one device of each player, and generating a virtual map of the treasure hunting game which corresponds to the real world. The operations further include generating an in-game solvable element that is solvable by the players and which aids the players in finding the at least one treasure upon being solved, and generating an in-game advantage element that aids the players in finding the at least one treasure. The operations further include integrating the at least one treasure, the solvable element, and/or the advantage element with content and/or a location associated with an advertising partner for directly engaging the players with the advertising partner without interrupting a gaming experience. The operations further include prompting an interface of the at least one device of each player to display the solvable element and/or the advantage element, and monitoring the at least one treasure to obtain treasure data from one or more treasure sensors. The operations further include obtaining winning player data associated with a winning player of the players who found the at least one treasure, and validating a legitimate finding of the at least one treasure by the winning player by processing and analyzing the player data, the winning player data, and the treasure data.

### BRIEF DESCRIPTION OF THE DRAWINGS

The embodiments illustrated herein are not limited to the precise arrangements, sequential steps, and dimensions shown. Like numerals indicate like elements throughout the drawings. In the drawings:

FIG. 1 is a schematic view of an exemplary embodiment of a computer-based system for implementing a location-based treasure hunting game.

FIG. 2 is a schematic view of a device of a player of the treasure hunting game.

FIG. 3 is a partial schematic view of a real world treasure and treasure housing which is hidden and searched for in the real world.

FIG. 4 is a schematic view of a game server of the computer-based system of FIG. 1.

FIG. 5 is a schematic view of a multimedia server of the computer-based system of FIG. 1.

FIG. 6 illustrates a user interface and virtual world generated by game server.

FIG. 7 illustrates a user interface and solvable element in the form of a word clue generated by game server.

FIG. 8 illustrates a user interface and a solvable element in the form of a song clue generated by game server.

FIG. 9 illustrates a user interface and various advantage elements generated by game server.

FIG. 10 illustrates an advantage element in the form of a range finder generated by game server.

FIG. 11 illustrates a flowchart of a method for generating solvable elements.

FIG. 12 illustrates a flowchart of a method for generating advantage elements.

FIG. 13 illustrates a flowchart of a method for verifying a legitimate finding of a particular treasure, wherein both the treasure and winning player are verified by the game server.

FIG. 14 illustrates a flowchart of a method for generating overlay elements to include in multimedia content as displayed on player devices.

### DETAILED DESCRIPTION

As used herein, the phrase “solvable element” can refer to an unsolved or uncompleted query, task, and/or game which is solvable or completable by the player(s) for aiding the player(s) in finding the treasure. Each solvable element could be in visual and/or auditory form such as a video, photo, audio clip, and/or holographic projection. The solvable element can be a clue, a puzzle, a question, a visual or auditory clip, e.g., a movie or song clip, a poem, an image, a graphic, a cartoon, a puzzle, a crossword, a mini-game, a fill in the blank, a challenge, and/or a task which is performable in the virtual and/or digital world. The term “clues” can be any information in a physical form and/or a digital form. Clues may be found, solved, won, purchased, blocked, or earned. The phrase “advantage element” may refer to a program or dataset for aiding the player in finding the treasure. An advantage element does not need to be solved in order to be used by the player. The phrase “treasure game” can refer to a live-action, location-based game in which players of the game search for a hidden item, i.e., treasure, in both the virtual world and the real world, and wherein the treasure is a physical object in the real world. The term “treasure” can refer to any physical and/or digital object. Post winning a game, the player of the game or the game operators may maintain possession of the physical and/or digital treasure. The treasure may also be redeemable for a sum of fiat currency, cryptocurrency, or another object or service.

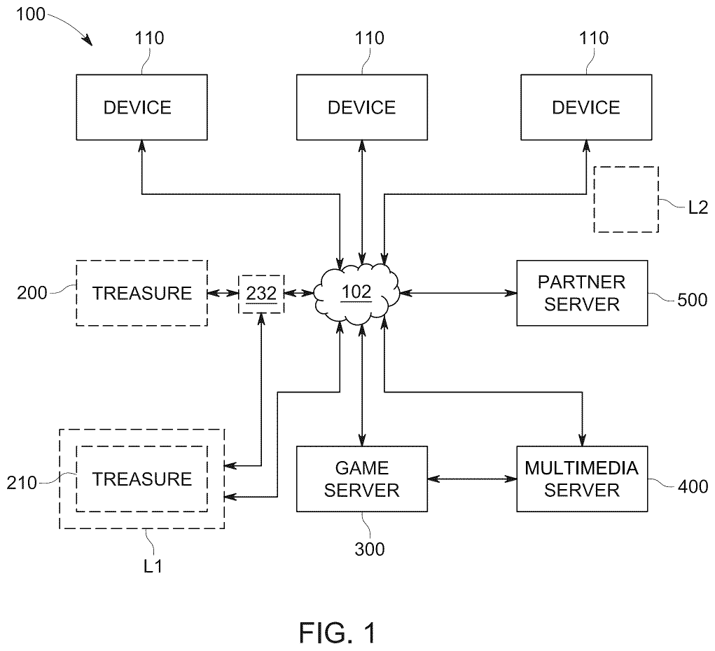

FIG. 1 is a schematic view of an exemplary embodiment of a computer-based system 100 for implementing a location-based treasure hunting game. The system 100 may include a network 102, one or more devices 110 of the users, e.g., the players and/or nonplayers enjoying the game and media content thereof, one or more treasures 200, 210 to be found by the players, a game server 300, and a multimedia server 400. In some embodiments, the system 100 may additionally include a partner server 500 of an advertising partner of the treasure hunting game. It is conceivable that in other embodiments, the system 100 may include different or additional elements from what is illustrated in FIG. 1.

The system 100 enables the players to engage in a live-action treasure hunt, which can be played by the players and/or watched as entertainment by the players or nonplayers. The system 100 incorporates physical and virtual elements. Thereby, the players may use their skills to find the various treasures in the physical and/or digital world.

Players may also participate in creating and viewing multimedia as a form of entertainment for themselves and others. Since the players act as both players and entertainers, they may also a mass a following of other people, including both players and non-players. The players may be rewarded for uploading content. For example, the players who achieve certain treasure hunting and/or entertainment goals may be awarded with in-game content, e.g., additional clues, in-game currency, and/or prizes, which may assist the player and/or the player's followers.

The treasure hunting game may be playable 24/7. The treasure hunting game may be played in seasons, such as three times a year in periods of four months each. Hence, the game period may be an annual game period. The game is designed such that all treasures are to be found by the end of the calendar year. The unfound treasure rolls over until the last game of the year, at which time the system 100 will ensure that all treasure will be found by the end of the calendar year. Thus, in a given game period, all treasure or prizes will be found. The game may be played in a particular geographical region. For example, the geographical region could be a nationwide region, encompassing all 50 states in United States of America, or within a particular state or a region of states. The geographical region may also comprise one or more countries.

The network 102 can be any type of communications network and/or combination of networks. The network 102 can comprise a public network, such as the Internet, an intranet, a local area network (LAN), wide area network (WAN), and/or some combination thereof. In general, communication between the servers 300, 400, 500 and the various devices 110 may occur via any desired network interface using any type of wireless connection, using a variety of communication protocols (for example UDP, TCP/IP, HTTP, S1v1TP, FTP), encodings or formats (for example HTML, JSON, XML), or protection schemes (for example VPN, secure HTTP, SSL).

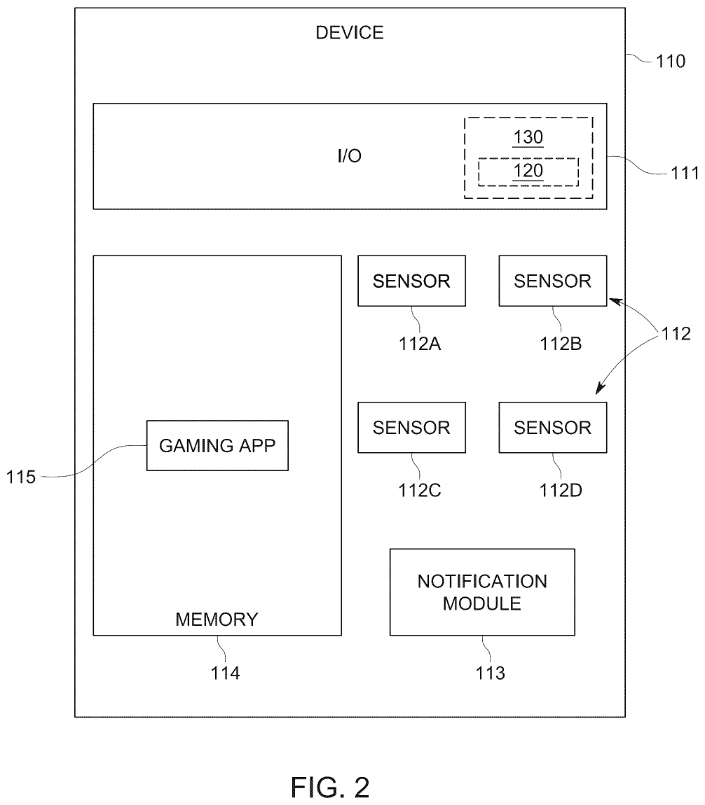

The devices 110 are connected to the servers 300, 400, and/or 500 via the network 102. The devices 110 may be any desired computing devices. The devices 110 may include any desired hardware and/or software for generating and receiving data. For example, as illustrated in FIG. 2, a device 110 may comprise a user interface 111 in the form of input/output devices 111, e.g., a display screen, lights, speakers, etc., one or more sensors 112, a notification module 113, a local data storage 114, and/or a gaming application 115 or other interface for communicating with the servers 300, 400, 500 via the network 102. The devices 110 may also include a battery. The devices 110 may also include other components known to those skilled in the art.

The devices 110 may be stationary, portable, and/or wearable. Each device 110 may be in the form of a computer, a tablet, a smartphone, a navigation system, a handheld GPS system, user equipment (UE), a smart television, a portable gaming device, a digital music player, a media player head-mounted display (HMD), a virtual and/or augmented reality (VR and/or AR) device, a wearable device, such as a headset, smart glasses, smart clothes, or smart shoes, data gathering implants, and/or other suitable data gathering electronic devices.

It is possible that each player may have one or more devices 110. For instance, a single user may have two or more devices 110 that can be connected with one another and/or separately connected to the network 102. In such cases, each device 110 may communicate with the game server 300 individually via the network 102. Additionally or alternatively, the player's first device 110 may communicate with the network 102, and the player's second device 110, or third, fourth, fifth, etc., may communicate with the first device 110 instead of directly with the network 102. Hence, at least one of the devices 110 may communicate with the servers 300, 400, 500. By way of example only, one player may have a smartphone and a wearable device, such as a smartwatch, that is connected to the smartphone and/or the network 102. Additionally, for example, one device, such as a smartphone, computer, or gaming console, may be used to play the treasure hunting game and one or more other devices, such as a wearable device, may include the sensors 112 for sensing the location data and capturing the multimedia content as the player explores the real world to find the treasure.

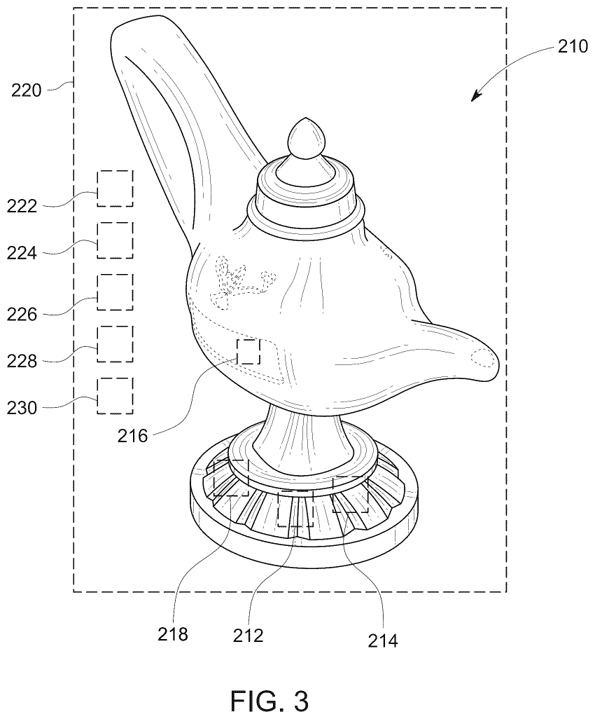

The one or more sensors 112 may include a location sensor, a speed sensor, an accelerometer, a gyroscope, an altimeter, a pedometer, a heart rate sensor, a microphone, and/or a camera. For example, as shown in FIG. 3, the one or more sensors 112 include a location sensor in the form of a positioning device 112A, a microphone 112B, a first camera 112C, and a second camera 112C. However, the one or more sensors 112 may include other and/or additional sensors. Each camera 112C, 112D may gather data relating to the player and/or the player's surroundings, such as the treasure 200, 210, the treasure housing 220, or the environment thereof.

The positioning device 112A can be any device or circuitry. For example, the positioning device 112A may comprise a GPS system, a Galileo positioning system, a Global Navigation satellite system (GLONASS), a BeiDou Satellite Navigation, or a Positioning system. As the player moves around with the device 110 in the physical world, the positioning device 112A can track the position of the player and provide the location data associated with the player to the gaming application 115.

The notification module 113 notifies, or otherwise presents information to the player, via various visual and/or auditory signals outputted by the input/output device(s) 111. The notification module 113 may comprise any desired software and/or hardware.

The local data storage 114 can be one or more computer-readable media configured to store data. For example, the local data storage 114 may store the location data and/or multimedia data collected by the sensor(s) 112. The local data storage 114 may also store any other appropriate data. Furthermore, the data may be stored elsewhere (for example, in a distributed database) and accessed remotely via the network 102.

The gaming application 115, executed by the device(s) 110 of each player, provides an interface between the player and the video game server 300 and/or the multimedia server 400. The gaming application 115 can include a collection module, an extraction module, a notification module, a treasure verification module, and/or native plugins. The gaming application 115 may also include a mobile graphics user interface. Each device 110 may or may not include a gaming application 115. For instance, instead of or in addition to the gaming application 115, each device 110 may include an interface, such as a browser interface, that is configured for displaying game and/or multimedia content of the game server 300 and/or multimedia server 400.

Each treasure 200, 210 may be hidden in a location which is initially unknown to the players. Each treasure 200, 210 may be in the form of a physical object, such as a wish lamp, a cube, or an egg. The treasure 200, 210 in the physical world may also have a digital counterpart or representation. Each treasure 200, 210 may or may not be connected to the network 102 via a network interface 218. Therein, each treasure 200, 210 may or may not be operably connected to the game server 300 and/or the multimedia server 400. For example, one treasure 200 may not be connected to the network 102, and another treasure 210 may be connected to the network 102. As shown, the treasure 200 may not be connected to the network 102. The treasure 210 may be connected to the network 102. Some treasures 200, 210 may be redeemable for an arbitrary monetary value or service(s). For example, a wish lamp 210 may be redeemed for a sum of money or allow the winning player to fulfill three wishes.

The treasure 200, 210, regardless of network connectivity, may include one or more sensors 212 and/or one or more identifying features 214, 216 (FIG. 3). The one or more sensors 212 and/or identifying features 214, 216 can be used to identify the treasure 200, 210. Additionally, the one or more sensors 212 and/or identifying features 214, 216 may allow access to game data and allow sponsors, hosts, and/or players to upload or download content to the game server 300 and/or multimedia server 400. The one or more sensors 212 may comprise a positioning sensor, such as a GPS locator and/or an RFID tag. The one or more identifying features 214, 216 may comprise a code, e.g., a unique series of numbers, a QR code, an RFID tag, and/or any other desired feature usable for uniquely identifying the treasure 200, 210 and/or advertising partner. For instance, a first identifying feature 214 may comprise a QR code that directs the device 110 of the winning player to game server 300 and/or multimedia server 400, and a second identifying feature 216 may comprise a QR code, mark, or logo, of an advertising partner. The treasure 200, 210 may also be in the form of a digital object, such as in-game content, a cryptocurrency, and/or a non-fungible token. Hence, the players may find the physical and/or digital treasures 200, 210 using their devices 110. Further, the players may find the treasures 200, 210 in a metaverse of an advertising partner, which may or may not be associated with the game in the real world.

The treasure 200, 210 can be housed within a treasure housing 220 (FIG. 3). The treasure housing 220 may house the treasure 210 therein. The treasure housing 220 may comprise a body with a door or hatch, one or more locks 222 for locking the treasure housing 220, an interface 224, one or more identifying features 226, and/or one or more sensors 228 for collecting housing data related to the location, orientation, movement, and state of the housing 220. The treasure housing 220 may also include a network interface 230 for connecting the treasure housing 220 to the treasure 210 and servers 300, 400, 500 via the network 102. The treasure housing 220 may also include other components and devices, such as a battery, solar panels, etc.

Each lock 222 may be a physical and/or digital lock, which may be unlockable by the player and/or game operator. The interface 224, if equipped, may be in the form of a display screen. The one or more identifying features 226 may include a unique series of numbers, a QR code, an RFID tag, and/or any other desired feature usable for uniquely identifying the treasure housing 220 and/or advertising partner. Each sensor 228 may comprise a camera or other optical sensor, a location sensor, a mechanical switch, an accelerometer, a microphone, and/or any other desired sensor. For instance, the sensor 228 may capture video data of the winning player opening the treasure housing 220.

In addition or alternatively to the sensors 212 and identifying features 214, 216 of the treasure 210 and the sensor(s) 228 of the treasure housing 220, the system 100 may include one or more sensors 232 for monitoring the treasures 200, 210, the treasure housings 220 which house the treasures 200, 210, and/or the hiding locations L1 (FIG. 1). The one or more sensors 232 may be operably connected to the treasures 200, 210 and the servers 300, 400, 500 via the network 102. Each sensor 232 may be mounted to an object, e.g., wall or doorway, adjacent to each treasure 200, 210 and/or treasure housing 220 thereof. Each sensor 232 may comprise a camera, a motion detection sensor, and/or a physical mechanical switch. Each sensor 232 may record data relating to the players, the player devices 210, the treasures 200, 210, and/or the treasure housings 220. Simultaneously or subsequently, each sensor 232 may transmit the data to the servers 300, 400 for subsequent processing.

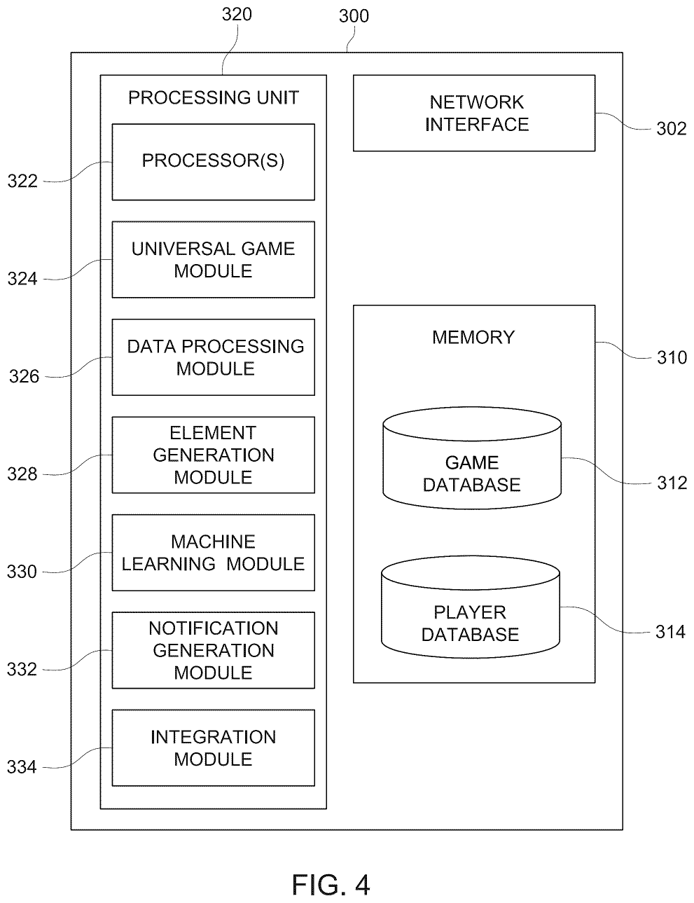

As shown in FIG. 4, the game server 300 may include a network interface 302, a computer-readable storage media 310, such as a memory, and a processing unit 320. The game server 300 hosts the treasure hunting location-based game, receives and analyzes inputs, e.g., the location data and/or multimedia data from the devices 110, and provides various game status updates to at least one of the devices 110 of the players. In some embodiments, the game server 300 may contain different or additional elements, and the various functions thereof may be distributed among its various elements in a different manner than described herein.

The network interface 302 establishes communication between the game server 300 and the network 102. The network interface 302 may establish direct or indirect communication with the devices 110 of the players, the treasure 210, and/or treasure housing 220. The network interface 302 can include any desired interface. The network interface 302 can include suitable components for interfacing with one or more networks, including, for example, transmitters, receivers, ports, controllers, antennas, or other suitable components.

The memory 310 stores game data and player data. The memory 310 may generally include any suitable computer readable media, such as a non-transitory computer readable storage medium, for storing instructions. The memory 310 can include a game database 312 and a player database 314. The game database 312 and/or the player database 314 may be part of or separate from the game server 300 such that the data is remotely accessed through the network 102. The game database 312 may store information associated with the treasure hunting game, such as clues, hints, the location of the treasures 200, 210, minigames, geographical data, and/or mapping data. The player database 314 may store information associated with the identity of the players and/or their devices 110, the location of the players, such as their previous location, current location, speed, mode of transport, and/or future projected location, the game status or progress of the players, and any other desired player data. In some embodiments, the memory 310 may include a single database, such as a combined game and player database.

The processing unit 320 generally includes one or more processors 322 for executing computer readable instructions. The processing unit 320 may further include a universal game module 324, a data processing module 326, an element generation module 328, a machine learning module 330, and a notification generation module 332. It is noted that the modules 326, 328, 330, 332 can be a part of or separate from the universal game module 324.

The one or more processors 322 may comprise any desired software and hardware. The one or more processors 322 may perform the various functions of the processing unit 320 described herein.

The universal game module 324 hosts and generates game content for the players. The universal game module 324 may access and store data in the databases 312, 314 of the memory 310. The universal game module 324 can further govern device connectivity and the security thereof.

The data processing module 326 may receive data associated with the activity of the players, by way of the various sensors 112 of the devices 110 of the players. For instance, the data processing module 326 may retrieve data by a background process of the one or more devices 110 of the player. The data processing module 326 may also receive and calculate the real time location of the devices 110, the treasures 210 via the sensors 212, and the treasure housing 220 via the sensor(s) 228. The data processing module 326 may also process the various collected data. Therein, for example, the data processing module 326 may calculate a distance and bearing between the treasure(s) 200, 210 and the player(s). The data processing module 326 may include a verification submodule which verifies a legitimate finding of the treasure 200, 210 by a winning player.

The element generation module 328 can generate game elements and/or various signals for the players of the treasure hunting location-based game and/or the game operator(s). The game elements can be based on certain parameters and/or data collected by the sensors 112 of the devices 110. The game elements can be generalized for all players and/or may be specifically keyed to a certain player. The element generation module 328 may also integrate game elements with content and/or locations of an advertising partner.

The machine learning module 330 may also receive and process game data and player data. For instance, the machine learning module 330 may generate hiding locations of the treasures 200, 210, game content, including game elements, and multimedia content based on the player data. The machine learning module 330 may generate possible hiding locations or general regions for hiding treasures based on player data, such a number and location of past or present players, geographical data, advertising partner data, population data, and/or treasure data, such as a type and a number of treasures. The machine learning module 330 may also calculate a hierarchy of potential receivers of subsequent game elements, like additional clues, hints, etc. Such a calculation may be based on player data such as game status, the geographical location of the players, and/or whether the players have achieved certain benchmarks or won subgames. The machine learning module 330 may also verify a legitimate finding of a treasure 200, 210 by a winning player. The machine learning module 330 may also integrate game elements with content and/or locations of an advertising partner.

The training material for the AI training algorithm may comprise a set of word puzzles, riddles, poems, sounds, themes, movie references, trivia or other facts, map data, memes, hints, etc. The training material may also comprise a conversation data structure for communicating with the players, including one or more possible conversation input nodes. The training material may further comprise recognition software for identifying facial features, voices, spoken phrases, walking gates, songs, facial patterns, etc.

The notification generation module 332 may notify the players about the various elements generated by the element generation module 328. For example, the notification generation module 332 may notify the players of each game, and of a particular region, about clues, the status of treasures, i.e., found or unfound, game content, game updates, periodical prizes and games, information pertaining to past and current treasure hunters, winners or losers of the game, and the player's followers. The notification generation module 332 may comprise any desired hardware and software. The notification generation module 332 may communicate various messages in a variety of manners known to the skilled artisan.

In some embodiments, the processing unit 320 may also include an integration module 334 for dynamically or directly engaging advertising partners with players (or nonplayers), without interrupting the gaming experience of the players (or entertainment experience of the nonplayers). In other words, the processing unit 320 may seamlessly integrate content associated with the advertising partner into the game. The processing unit 320 fundamentally changes how advertising is created and viewed because the advertising content no longer functions as an unrelated or semi-related ad but rather as an in-game element that is fundamental to the enjoyment and progression of the game being played by the players and/or viewed as entertainment by nonplayers. It conceivable that the integration module may be incorporated as part of the game server 300 and/or multimedia server 400.

Advertising partners may directly interact and guide the behavior of the players in a fun, interactive way that drives awareness and engagement with their products and services. The integration of brand-specific solvable elements, e.g., clues, challenges, tasks, or other activities, into the game creates a memorable experience for players while increasing brand recall and loyalty. With the in-game activities, the game server 300 can drive measurable business results such as increased web traffic or sales, increased foot traffic in virtual or real world locations L2, increased product or service trial adoption, and/or increased social media engagement and followers, all while providing players and nonplayers alike with a truly immersive and enjoyable experience.

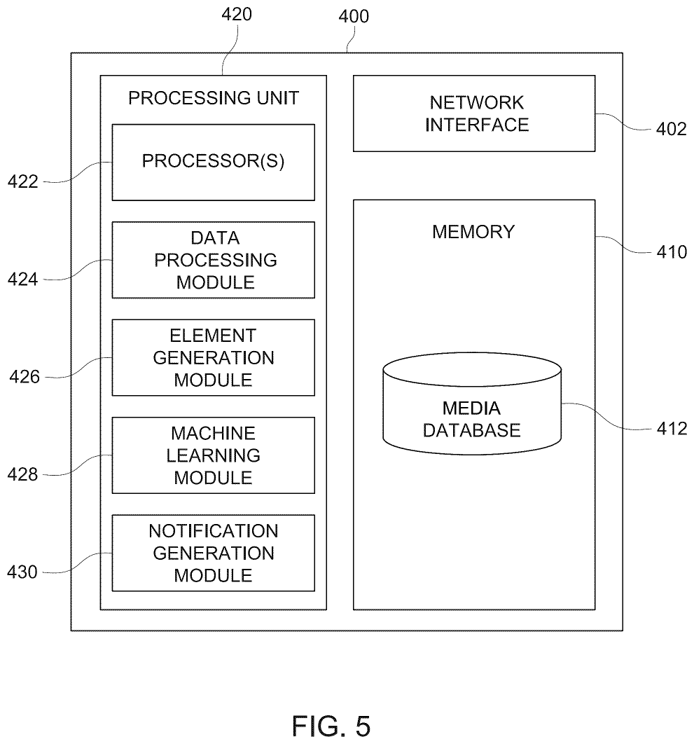

As shown in FIG. 5, the multimedia content server 400 may include a network interface 402, a computer-readable storage media 410, for example a memory with one or more databases such as a multimedia database 412, and a processing unit 420. The multimedia server 400 hosts the media associated with the treasure hunting game and/or the players thereof. For instance, the multimedia server 400 may function as a multimedia platform for viewing game content and/or player captured content. The multimedia server 400 is connected to the servers 300, 500 via the network 102. Alternatively, the multimedia server 400 may be integrated into or be in direct communication with the game server 300. In some embodiments, the multimedia server 400 may contain different or additional elements, and the various functions thereof may be distributed among its various elements in a different manner than described herein.

The network interface 402 establishes communication between the multimedia server 400 and the network 102. The network interface 402 can include any suitable components for interfacing with one or more networks, including, for example, transmitters, receivers, ports, controllers, antennas, or other suitable components.

The memory 410 may store and/or stream any desired data. The multimedia content may comprise stored data and/or streamed data. The multimedia content may comprise video, audio, text, images or combinations thereof. The data stored in the multimedia server 400 may be provided for display in the gaming application 115 of the devices 110, web pages, and/or or any other web content areas. The memory 410 may also store social connection data, which is indicative of social connections between user accounts associated with one or more social networking services.

The processing unit 420 generally includes one or more processors 422 for executing computer-readable instructions. The processing unit 420 may further include data processing modules for performing various functions, such as categorizing the media, editing the media, reformatting the media, etc. For instance, the processing unit 420 may include a data processing module 424, an element generation module 426, a machine learning module 428, and a notification generation module 430.

The one or more processors 422 may comprise any desired software and hardware. The one or more processors 422 may perform the various functions of the processing unit 420 described herein.

The data processing module 424 may receive data associated with the treasure hunting game and/or the activity of the players by way of the various sensors 112 of the devices 110 of the players and sensors 212, 228, 232. The data processing module 424 may also process game data, player data, and multimedia data provided by the players and/or the game operators. Therein, the data processing module 424 may categorize the media, edit the media, reformat media, and/or alter the media in any desired manner.

The element generation module 426 can generate media elements for the players of the treasure hunting game. Such media elements can be based on certain parameters and/or data collected by the sensors 112, 212, 228, 232. For instance, the element generation module 426 may generate a highlight reel of player videos and/or images, a reel of media based on geographical regions, a reel of media based on the type of treasure, and/or a list of the winners and their respective winnings.

The element generation module 426 may generate a video-capturing signal upon determining, in tandem with the element generation module 328, that a player has found the treasure housing 220 and/or treasure 200, 210. Therein, the camera 112C, 112D of the player's device 110 may automatically turn on and/or the player may be prompted to turn on the camera 112C, 112D of his device 110.

The element generation module 426 may also generate a media team signal which is subsequently outputted via the notification module 432 to the game operators and/or a third-party media team. The media team signal may also initiate a debrief procedure and a winnings procedure for debriefing the winner and informing the winner how to obtain the monetary and/or service value associated with the treasure.

The element generation module 426 may also generate content associated with one or more hosts. A host of a game may act as an entertainer, narrator, commentator, facilitator, promoter, and/or moderator. A host may or may not be a player of a past, present, or future game. A host may or may not be a human. The element generation module 426 may generate virtual hosts, such as an AI host, for showcasing entertainment. The element generation module 426 may also generate a real-time virtual representation of a live-acting or pre-recorded host in the virtual world. The element generation module 426 may also automatically schedule or otherwise connect a host, in the real world, with a particular region and/or multimedia team.

The machine learning module 428 may also process the collected data and accordingly generate multimedia content. The machine learning module 428 may determine which players to promote based on player in-game performance. Players with more wins and achievements will be promoted to a greater number of other users. The machine learning module 428 may also promote content in various underperforming regions wherein players are not engaging with multimedia content. The training material for the AI training algorithm may comprise a set of editing parameters for photo and/or video editing. The training material may further comprise recognition software for identifying facial features, voices, spoken phrases, walking gates, songs, facial patterns, etc.

The notification generation module 430 may notify the players about the various elements generated by the element generation module. The notification generation module 430 may comprise any desired hardware and software. The notification generation module 430 may communicate various messages in a variety of manners known to the skilled artisan.

In some embodiments, the system 100 may further include a secondary or advertising partner server 500 which is connected to the game server 300 and/or the multimedia server 400 via the network 102. The partner server 500 may include a network interface, a computer-readable storage media, such as a memory, and a processing unit. The partner server 500 may host game content and/or content relevant to the partner's product(s) and/or services. For instance, the partner server 500 may then comprise game clues which are necessary to play the game and which also include information about the partner's product(s) and/or services.

In operation, the partner server 500 may host game content associated with the game. The partner server 500 may host content that is generated by the game server 300 and/or the multimedia server 400. Initially, for instance, the element generation module 328 may generate content, such as clues, or portions thereof. Subsequently, the game server 300 may send the content to the partner server 500, which hosts the content, thus allowing the player's devices 110 to access the content via accessing the partner server 500. Player traffic is thereby funneled to the partner server 500. Players may then view the game content, and other non-game content associated with the advertising partner, which is hosted on the partner server 500. Additionally or alternatively, the partner server 500 may generate game content in tandem with the game server 300 and/or multimedia server 400. For instance, the element generation module 328 may generate the clue and the partner server 500 may incorporate the clue in advertising content. Therein, the advertising content, and the clue included therein, may be hosted on the game server 300, the multimedia server 400, and/or the partner server 500. After the player performs the contingent action, the game server 300 will automatically register the completion of the contingent action and subsequently send the requisite information to the player.

The game server 300 may automatically generate an advertising partner report which is based in part upon game data and/or multimedia data associated with the players and/or nonplayers. The advertising report may identify impressions, the number of times a location L1, L2 was visited by the player(s), data associated with a sponsored treasure 200, 210, game, or region, such as how many times the sponsor's name was mentioned or seen by the players or nonplayers and where, traffic associated with the advertising partner server 500, data associated with contingent-action game elements, and/or advertising data associated with the multimedia server 400. The game server 300 may automatically generate the advertising partner report in real-time. The advertising partner report may be comprised of audio and/or visual data. Accordingly, the game server 300 may subsequently output the advertising partner report to the partner server 500.

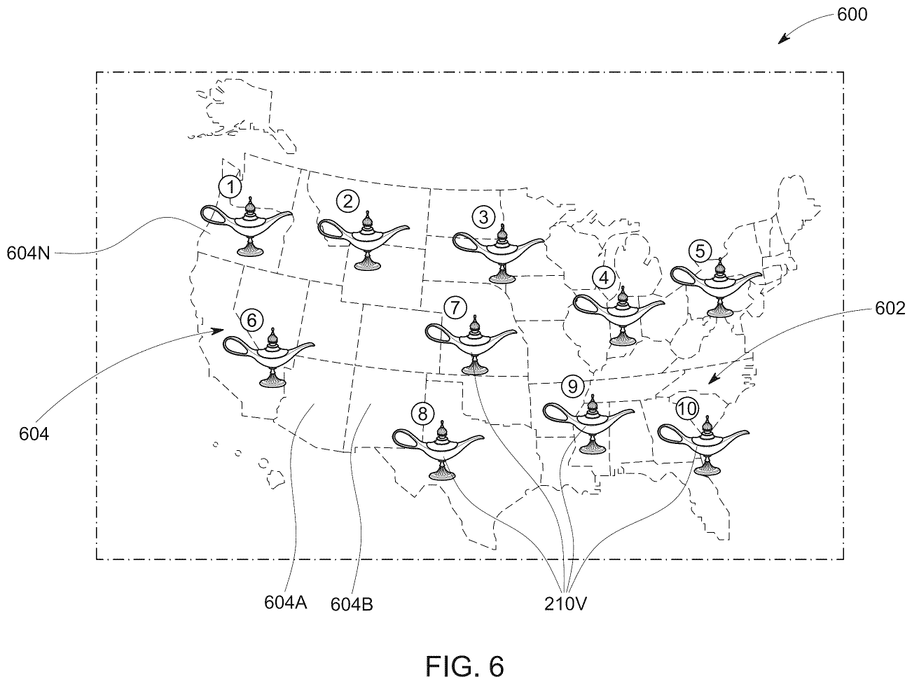

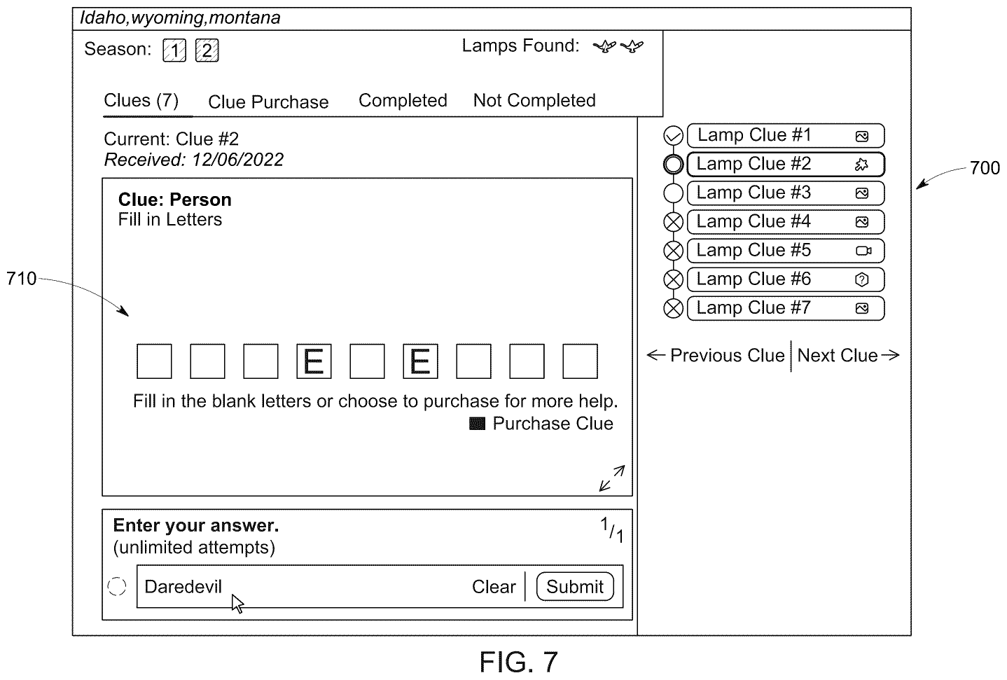

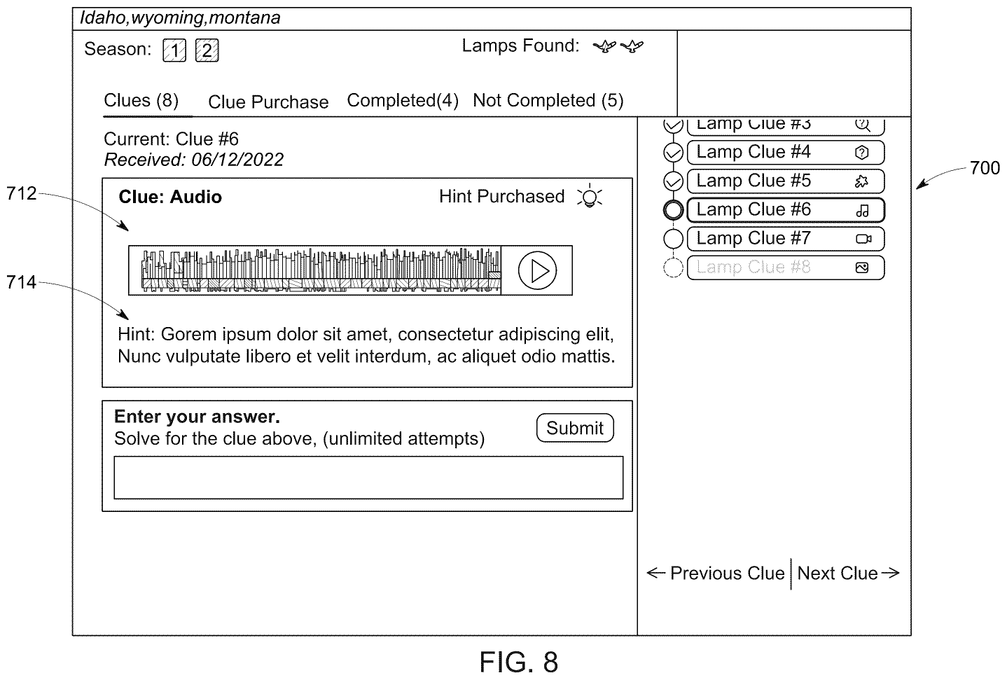

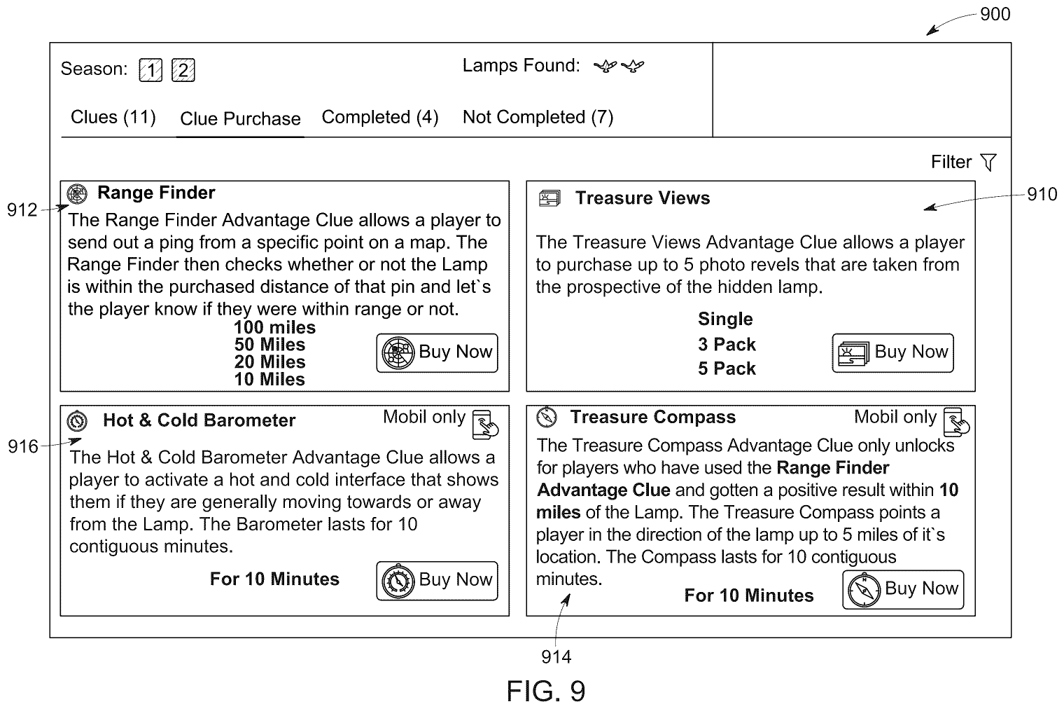

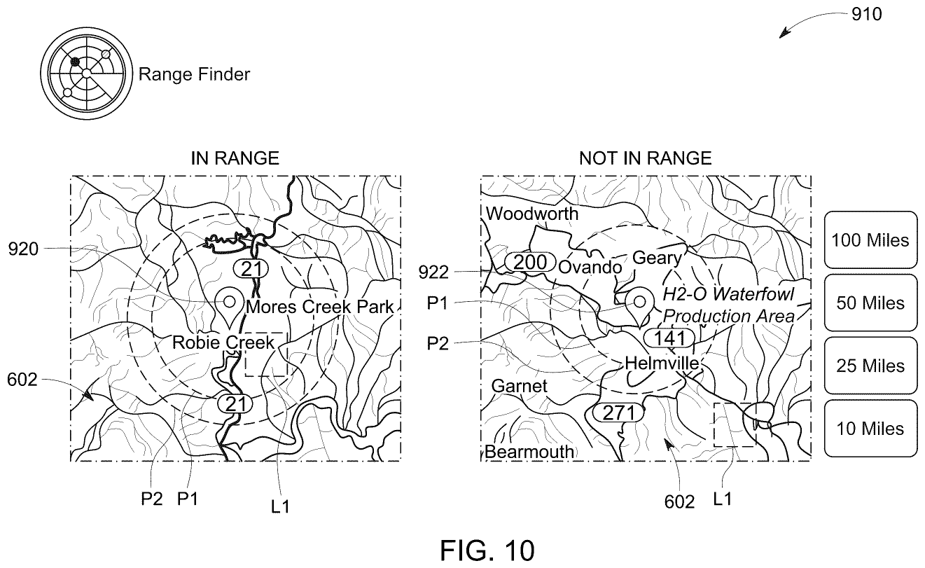

Referring now to FIGS. 6-12, the processing unit 320 of the game server 300 can generate various in-game elements, such as a virtual world 600, one or more clue interfaces 700 for one or more in-game solvable elements 710, 712 which the players may solve to aid the players in finding the treasure 200, 210 in the real world (FIGS. 7-8), and one or more advantage interfaces 900 for one or more in-game advantage elements 910, 912, 914, 916 (FIGS. 9-10).

The processing unit 320 may also generate treasure tracking data for monitoring the locations of the treasures 200, 210 and their treasure housing 220 in real time. The processing unit 320 may also generate a real-time scorecard which tracks the status of the treasures, the location of found treasures, the date and time of when treasures were found, the winners and losers of the game, and any other desired game and/or entertainment related information.

Furthermore, the processing unit 320 may also determine possible hiding locations for the treasure 200, 210. For instance, the element generation module 328 and/or machine learning module 330 may determine ideal hiding locations, such as an exact location or a region, based on population data, regional safety or crime data, mapping data such as roadways or buildings, locations of sponsors, and/or player location data.

Referring specifically to FIG. 6, the virtual world 600, generated by the processing unit 320, may include a virtual map 602 which indicates one or more regions or general areas 604, e.g., 604A, 604B, 604N, in which one or more treasures 200, 210 are hidden. The treasures 200, 210 can be represented by in-game treasure elements 210V. The virtual world 600 may roughly correspond to the real world, including geography, terrain, state or city boundary lines, roadway or navigable water data, arbitrary boundaries encompassing various regions, and weather data. The map 602 may have real-time data included therein, such as player position(s), in-game element(s), possible advantages, options for obtaining more information, and/or the number of treasures 200, 210 found and/or lost. For instance, the element generation module 328, in tandem with the multimedia server 400, may generate a link or overlay element that is keyed to a particular location on the map 602, wherein the link or overlay element indicates a particular treasure presently being found. The treasure finding can be shown in a scorecard and/or the interactive map 602.

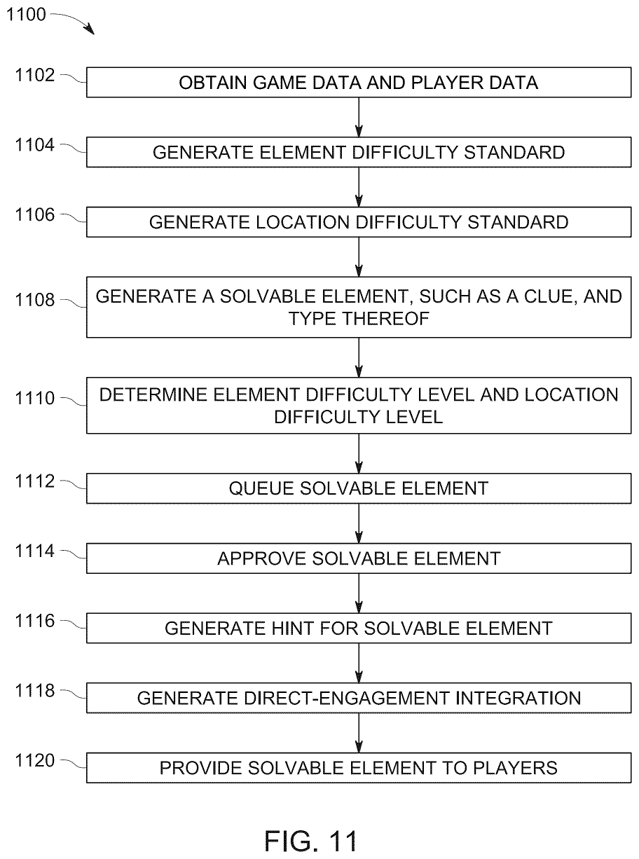

Referring specifically to FIG. 11, there is shown a method 1100 for generating solvable elements 710, 712. The method 1100 can be performed by the processing unit 320. The solvable elements 710, 712 are provided to the players unsolved, and it is up to the players to solve the solvable elements 710, 712 using their various skills.

At step 1102, the game server 300 obtains game data and player data. The game data and/or the player data may be inputted by game operators and/or players or sensed by the devices 110, the treasures 210, and/or treasure housings 220 or any other desired sensors in communication with the game server 300. The game data may include data associated with the game, the rules thereof, the various locations of treasures 200, 210, and/or generated game elements. The player data may include player identity, various player characteristics, player location, metadata associated with the player's real world actions, and the game(s) which the player is actively playing.

At step 1104, the game server 300 determines the difficulty standard of the solvable elements. For example, the game server 300 may automatically generate a difficulty scale, e.g., a rating from 1 to 5, in which the solvable elements are categorized. The machine learning module 330 may solve pre-generated solvable elements and accordingly generate the difficulty scale based on metrics of the time it took to solve the solvable elements, reading level, retention metrics, analytical skill, mathematical skill, obscurity of reference by analyzing usage of an item or subject in various databases, and relative size or length of the various solvable elements.

At step 1106, the game server 300 may generate a location difficulty standard of each solvable element. An answer to a solvable element may refer to a particular generalized location, or region, associated with a corresponding exact location of a treasure 200, 210. The machine learning module 330 may determine the location difficulty standard, e.g., a vague to obvious rating from 1 to 5, that is based on a proximity zone corresponding to the generalized location, a determination of a relative distance (in between the generalized location and a player(s) and/or a treasure location), an obscurity or remoteness factor based on travel and/or usage data of the generalized location, map data, and/or player location data.

At step 1108, the game server 300 may generate the solvable elements and types thereof for use in the treasure hunting game. For example, the processing unit 320 may obtain trivia data, map data, audio visual data, treasure data, and/or player data. Thereafter, the processing unit 320 may generate an answer that discloses or hints at a generalized location associated with the exact location of the treasure 200, 210. The processing unit 320 may autonomously or semi-autonomously generate the solvable elements for the game, based upon received data inputted by users and/or an AI training algorithm. The processing unit 320 may generate the solvable elements based on sensed data such as the type of treasure 210, game data, the exact location L1 of the treasure 200, 210, the region in which the treasure 200, 210 is hidden, one or more player characteristics of players in a given region, a number of players, a physical location of a player, a difficulty level, a location rating, a virtual or physical location L2 of the advertising partner, and/or one or more characteristics of and/or inputs from advertising partners associated with the treasure 200, 210. The processing unit 320 may then generate questions, minigames, puzzles, and/or skill-based tasks that if solved or completed unlock the answer.

The processing unit 320 may further generate graphical user interfaces for viewing the solvable elements and for inputting information, which are accordingly displayed on the devices 110. For example, the processing unit 320 can generate a word puzzle 710 which if solved discloses a name of a person (FIG. 7). The name of the person hints at a region in which the treasure 200, 210 is hidden. The processing unit 320 can also generate an audio clue 712 which if solved discloses a source of the song or audio clip (FIG. 8). In turn, the solved audio clue 712 hints toward the hiding location of the treasure 200, 210.

The game server 300 may generate any desired number of solvable elements for a given treasure. Each solvable element can be categorized by its type or common characteristics to one another, e.g., word clues, audio clues, visual clues, etc. It is noted that the game server 300 may generate solvable elements in real time based on player data and/or game data. For example, the game server 300 may generate solvable elements that may be easier or more direct if the players are having a difficult time finding the treasure or if a game season is coming to a close within a set number of days. In this way, the game server 300 ensures that the treasures 200, 210 will be found at the end of each season.

At step 1110, the game server 300 may determine the element difficulty level and location difficulty level of a given solvable element. For the assignment of the element difficulty level, the processing unit 320 can compare the present solvable element to the pre-generated rating to determine a similarity factor to the pre-generated and solved solvable elements. Thereafter, the processing unit 320 can accordingly assign a difficulty rating to the present solvable element. For the assignment of the location difficulty level, the processing unit 320 may determine the obscurity of the hint or compare the generalized location disclosed in the answer to the exact location of the hidden treasure 200, 210. For example, if a solvable element only discloses a general region or state wherein the treasure 200, 210 is hidden, the machine learning module 330 will assign a relatively low difficulty rating to this solvable element because it is outside of a precalculated proximity zone, such as within 100 miles of the exact location of the treasure 200, 210.

At step 1112, the game server 300 may queue the generated solvable element for subsequent processing. For example, the processing unit 320 may store the generated solvable elements in the game database 312 of the memory 310.

At step 1114, the game server 300 may approve the generated solvable element. For example, a human game operator may review the generated solvable element, verifying its usability, accuracy, and difficulty ratings. Additionally, for example, the machine learning module 330 may solve the generated solvable element and approve the solvable element based on certain factors, such as the time it took to solve and its training algorithm.

At step 1116, the game server 300 may generate one or more hints for a given solvable element and subsequently set a hint difficulty level. For example, the machine learning module 330 may generate a hint 714, such as an additional description, that helps the player solve the solvable element 712 (FIG. 8). The machine learning module 330 may generate the hint based on the generated solvable element and player data. For example, if numerous players cannot solve the solvable element after so many days and/or attempts, the machine learning module 330 may generate one or more hints. Thereafter, the machine learning module 330 may subsequently modify a hint and/or disclose additional hints responsive to the generated hint and based on player data. The game server 300 may also determine the availability of hints, e.g., providing hints within a certain time window. Furthermore, the game server 300 may determine the pricing of the hints, if purchasable, based on player data, difficulty ratings of solvable elements, present demand, and/or advertising partner preferences.

At step 1118, the game server 300 may generate a direct-engagement integration with an advertising partner of the treasure hunting game. The game server 300, via the machine learning module 330 and/or integration module 334, may associate the treasure 200, 210, a solvable element, and/or a hint for the solvable element with an advertising partner. For example, the machine learning module may 330 may obtain marketing material or other information from the advertising partner. Thereafter, the machine learning module 330 may incorporate portions of the information into the solvable element. For instance, the solvable element may prompt a player to travel to a virtual or real world location L2 which is associated with the advertising partner. Additionally, for example, the machine learning module 330 may embed a solvable element within a video associated with the advertising partner. Thereby, the game server 300 may directly engage the players with advertising partners without interrupting the gaming experience of the player. Thereby, any marketing association will not be seen as a distraction but rather a fundamental and enjoyable portion of the gaming experience.

At step 1120, the game server 300 may provide the solvable element to the players. The notification generation module 332 may output the solvable element to the devices 110 and/or the servers 400, 500. The element generation module 328 may schedule the clue for mass publishing to notify all of the players at the same time or individual publishing to notify the players individually at unique intervals and/or conditionally upon certain actions performed by the player.

The element generation module 328 may also generate clue notifiers which notify a player of when, where, and/or how a clue may be accessed. Thereafter, the game server 300 may receive the answers provided by the players, determine whether the answers are correct (or within a margin of acceptable error), and repeat the process to generate subsequent solvable elements and hints.

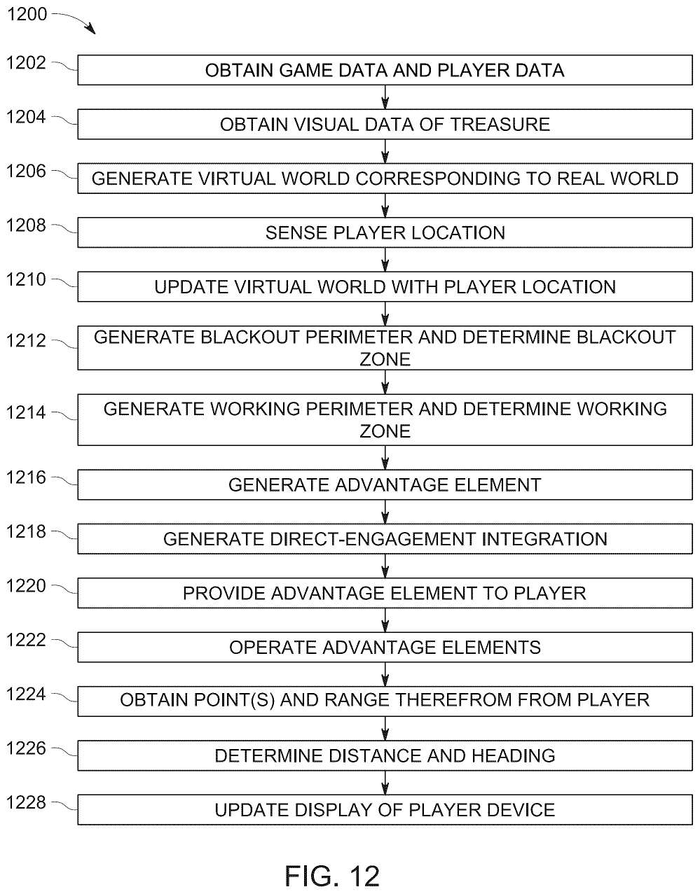

Referring specifically to FIG. 12, there is shown a method 1200 for generating advantage elements, such as the advantage elements 910, 912, 914, 916 shown in FIG. 9. The method 1200 can be performed by the processing unit 320. For instance, the element generation module 328, the machine learning module 330, and/or the integration module 334 may autonomously or semi-autonomously generate the advantage elements.

The advantage elements may comprise in-game elements, such as graphical user interfaces with location-based guiders, that help the player find the location of the treasure 200, 210. For example, the advantage elements may include a treasure view 910, which may include auditory and/or visual data such as one or more photos taken from the hiding location L1 (FIG. 9). Additionally, for example, the advantage elements may include real time location-based user interfaces, such as a range finder 912 (FIG. 10), a treasure compass 914, and a barometer 916, that help the player locate the hidden treasure 200, 210.

At step 1202, the game server 300 may obtain game data, including treasure data, and player data. At step 1204, the game server 300 may obtain visual data of the treasure. A game operator may take photos or videos of the area surrounding the treasure 200, 210 and/or the sensors 212, 228, 232 may automatically provide the visual data to the processing unit 320 in real time. At step 1206, the game server 300 may generate the virtual world 600, including the in-game map 602. At step 1208, the game server 300 may sense locations of the players in real time. More particularly, the processing unit 320 may obtain the location data from the sensor(s) 112 of the device(s) 110 of each player. At step 1210, the game server 300 may input and update the players' locations on the map 602 of the virtual world 600. Thereafter, the game server 300 may output an updated map 602 for display on the device 110 of the player.

At step 1212, the game server 300 may generate a first, blackout perimeter P1 around the treasure 200, 210 and determine a corresponding blackout zone therein. The first perimeter P1 may be a set distance away from the treasure, e.g., a radius of 20 miles. The blackout zone is defined by the perimeter P1, and thus the blackout zone encompasses the area within the perimeter P1. As discussed in more detail below, the game server 300 may prevent the use of the advantage elements within the blackout zone. The game operator may determine the size and shape of the perimeter P1. The machine learning module 330 may also automatically determine the perimeter based on game data, treasure data, and player data. For example, if only two days are left and no players have traveled into the blackout zone inside of the perimeter P1, the machine learning module 330 may reduce the size of the perimeter P1 so that the treasure 200, 210 is easier to find using the advantage elements.

At step 1214, the processing unit 320 may generate a second, working perimeter P2 around the treasure 200, 210 (or other starting point) and determine a corresponding working zone in between the two perimeters P1, P2. The second perimeter P2 may be a set distance, such as a radius of 50 miles, away from the treasure 200, 210 (or other starting point). The second perimeter P2 is larger than the first perimeter P1. The working zone encompasses the area in between the two perimeters P1, P2. As discussed in more detail below, the processing unit 320 may generate the working perimeter P2 based on player input and/or automatically based on game data. Additionally, the machine learning module 330 may set and adjust the size of the perimeter P2, for example by increasing its size to increase the working zone.

At step 1216, the game server 300 may generate one or more advantage elements for aiding the player (or group of players) in finding the treasure 200, 210. For example, upon request of the player and/or determination of the processing unit 320, the element generation module 328 and/or the machine learning module 330 may generate the treasure view(s) 910, the range finder 912, the compass 914, and/or the barometer 916. The player may accordingly select which advantage element they would like to utilize.

To generate the one or more treasure views 910, the processing unit 320 may obtain the inputted and/or sensed treasure data from the treasure data stored in the game database 312 and/or from the sensors 212, 228, 232. For example, the treasure data for the treasure view 910 may be captured by a game operator at the time of hiding the treasure 200, 210. A game operator may take one or more photos or videos of the surrounding area, as if it is the view of the treasure looking outwardly into the real world. Additionally or alternatively, the processing unit 320 may obtain the treasure data in real time from the sensors 212, 228, 232. Before providing the image data, the processing unit 320 will remove any metadata related to the location at which the image data was captured. To generate the location-based advantage elements 912, 914, 916, the processing unit 320 will generate graphical user interfaces and update the map 602 with the player location data and the perimeters P1, P2.

At step 1218, similarly to the method 1100, the game server 300 may generate a direct-engagement integration. Thereby, the content and/or location of the advertising partner may be integrated within the advantage elements 910, 912, 914, 916.

At step 1220, the game server 300 may provide the generated advantage elements 910, 912, 914, 916 to the corresponding players. The notification generation module 332 may cause the display(s) 111 of the device(s) 110 of the players to display the graphical user interfaces of the advantage elements 910, 912, 914, 916.

At step 1222, the game server 300 may operate the advantage elements 910, 912, 914, 916. The processing unit 320 may display and initiate use of the advantage elements 910, 912, 914, 916 for a specified time period and/or number of uses. The processing unit 320 may render each advantage element operable for a respective player upon sensing that the respective player is in the working zone, and render each advantage element inoperable upon sensing that the respective player is in the blackout zone. For example, the compass 914 may initialize a needle spinning procedure upon the player entering the blackout zone. Additionally, for example, the barometer 916 may initialize a too hot (or too loud) procedure wherein its needle registers its maximum limit. The advantage elements may shake the UI and/or vibrate the device 110 itself upon entering the blackout zone. For the treasure views 910, each device 110 may display the treasure data. For the location-based advantage elements 912, 914, 916, the processing unit 320 may further perform the following steps to operate the location-based advantage elements 912, 914, 916.

In operation, as noted above, the player's skill may at least partially determine the working zone. Optionally at step 1224, and with respect to the range finder 912, the player can be prompted to input starting point(s) 920, 922 on the map 602 and select the perimeter range therearound. In other words, the processing unit 320 may query the player to obtain one or more starting locations, i.e., points 920, 922 on the map 602, which serve as a center point for a corresponding working perimeter P2 therearound (FIG. 9). Optionally, the player may additionally select a predetermined set range, e.g., the working perimeter P2 in miles from the corresponding point 920, 922. Hence, if the player correctly estimates a given starting point 920, then the second perimeter P2 and the working zone are thus determined at least in part by the player's skill.

At step 1226, the game server 300 may determine the distance and heading to the working and/or blackout zones, as calculated from the device 110 of the player and/or point(s) 920, 922. Therein, the game server 300 may determine the distance and direction of the player from the first and/or second perimeters P1, P2. The game server 300 may only initiate this step upon determining that the player is presently within the working zone in between the two perimeters P1, P2.

With respect to the range finder 912, the processing unit 320 may determine whether the treasure 200, 210 is within the chosen range from the point(s) 920, 922 inputted by the player. If the point 920 is within the range, the range finder 910 may overlay a green film over the map 602. Alternatively, if the point 922 is not within the range, then the range finder 910 may overlay a red film over the map 602. Thereby, to limit hacking and wrongfully obtaining the location of the treasure 200, 210, the processing unit 320 only outputs a simple yes/no (green/red) output to the devices 110 of the players instead of any treasure location data or perimeter data.

The treasure compass 914 and the barometer 916 may guide the player toward the treasure 200, 210. More particularly, for security and anti-hacking purposes, the compass 914 and the barometer 916 can calculate the distance and direction from the device 110 of the player to a first perimeter P1 around the treasure 200, 210. The exact location of the treasure 200, 210 is never sent to the devices 110 of the players, and therefore prevents the advantage elements from being hacked to wrongfully obtain the location L1 of the treasure 200, 210.

It is noted that the treasure compass 914 and the barometer 916 may or may not be contingent on the player successfully completing the range finder 912. For instance, the processing unit 320 may limit the use of subsequent advantage elements 914, 916 unless and until the player obtains a specific range from the treasure 200, 210, such as within a 10-mile radius.

At step 1228, the game server 300 may update the display 111 of each device 110 of the player. Therein, the game server 300 will update the UIs of the advantage elements to display the player's current location and adjust the various indicators to inform the player that they are either moving closer to or further away from the blackout zone. The game server 300 may continue to update the device 110 of the player until the specified time period has expired and/or number of uses have been completed. Thereafter, the game server 300 may repeat any of the aforementioned steps.

In some embodiments, the game server 300 may provide elements, e.g., the solvable elements and/or the advantage elements, on a contingent basis such as whether a certain action has been completed by the player and/or a group of players. Such elements can be referred to as action-contingent game elements. As used herein, “action-contingent game elements” may refer to aspects of the game that require the player (or nonplayer) to perform a certain action in order to play the game (or access and view the various aspects of the game as entertainment). For example, the element generation module 328 may generate action-contingent clues or portions of clues such as hints which make solving the whole clue much easier. As used herein, “action-contingent clues” may refer to clues to solve the game, or portions of the game, which are contingent on a certain action being performed by the player.

Action-contingent game elements may comprise any virtual and/or real world actions performed by the player. Action-contingent game elements may comprise puzzles, questions, hints to solve a clue, the unlocking of additional clues, etc., which are all contingent on certain actions. For example, access to a clue, or portions thereof, may be contingent upon the player traveling to a physical location L2, which may be associated with the advertising partner, download data, such as an app which may be associated with the advertising partner, watch a video, and/or upload data, such as creating user content which shows the player performing a certain action which may be associated with the advertising partner. Hence, the player may be required to travel to the advertising partner's physical location L2 at which the player may perform the contingent action, e.g., recite a password, in order to achieve the award or unlock the next progression of the game. Additionally, for example, access to a clue, or portions thereof, may be contingent upon the player answering one or more questions, performing a dance move, making a facial expression, or making a specific movement with their finger on their device 110, such as motioning the first letter of the name of the advertising partner. Further, for example, the treasure 200, 210 may be hidden at the location L2 itself. Thus, the player may receive the treasure 200, 210 by engaging with the advertising partner. Still further, for example, the contingent action may be simply using the portal or UI of the game and/or multimedia server 400, which features and requires the player or nonplayer to engage with other players and/or the advertising partner. Therein, the advertising partner's name, branding, or other content may be integrated within the UI of the game and/or entertainment branch thereof.

The action-contingent clues may or may not be associated with an advertisement from an advertising partner. Since such action-contingent clues require a specified action, they cannot be skipped or otherwise ignored by the player. The action-contingent clues create a more effective and direct engagement between the player and the advertising partner. Advantageously to both player and advertising partner, the action-contingent clues are all in-game clues which require in-game activities, e.g., in-game challenges, locations, questions, puzzles, etc.

The game server 300 may automatically determine when the player (or nonplayer) has performed the contingent action needed to progress the game (or view the game as entertainment). For example, the game server 300 may determine that the player performed the contingent action by physically traveling to a location L2 of the advertising partner, via the sensors 112 of the player's device 110. Additionally, for example, the game server 300 may determine that the player has performed a certain action in their player uploaded content on the multimedia server 400 via AI audio and/or facial recognition software of the machine learning module 330. Thereafter, the game server 300 may provide the requisite information or subsequent elements to the player after solving the action-contingent elements.

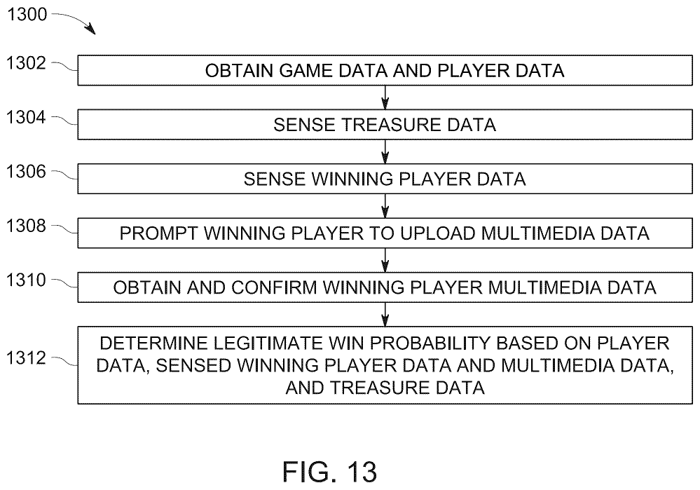

Referring now to FIG. 13, there is shown a flowchart for a method 1300 to verify a legitimate winner. The verification method 1300 may verify that a player, or group of players, has indeed been the first person to find the treasure 200, 210. The method 1300 reduces a possibility of foul play throughout the entire game process, such as reducing the ability to spoof a location, illegitimately obtain solvable game elements and/or advantage game elements, and/or misappropriate identities of players. The processing unit 320, such as the data processing module 326 and/or the machine learning module 330, may perform the steps of the method 1300.

At step 1302, the game server 300 may obtain game data and player data. At step 1304, the game server 300 may sense treasure data 1304. The treasure data 1304 may have been obtained at the time of hiding the treasure, by a game operator, and/or in real time by the sensors 212, 228, 232.

At step 1306, the game server 300 may sense winning player data. Such data may include player location, audio, and/or visual data. For instance, each device 110 may automatically record the player upon being prompted by the game server 300 after the game server 300 receives a treasure found signal from the device 110, the treasure 210, and/or the treasure housing 220.

At step 1308, the game server 300 may prompt the winning player to upload multimedia data to the multimedia server 400. For example, upon finding the treasure housing 220, the winning player may scan an identifying feature 226 thereof, which causes their device 110 to communicate with the game server 300. The game server 300 may then output a winner procedure to the device 110, which prompts the player to film themselves opening the treasure housing 220 and obtaining the treasure 200, 210.

At step 1310, the game and/or multimedia server 300, 400 may obtain and confirm the receipt of the multimedia data of the winning player. For example, after the winning player uploads their multimedia data to the multimedia server 400, the multimedia server 400 sends a receipt signal to the game server 300. The game server 300 confirms the upload of the multimedia data and proceeds with the verification process. The game server 300 can also send a confirmation signal to the winning player.

At step 1312, the game server 300 may determine a legitimate win probability that is based on player data, sensed winning player data and multimedia data, and treasure data. For example, the machine learning module 330 may include a facial, voice, and/or emotion recognition and tracking submodule for processing the auditory and/or visual data of the winning player whilst the winning player is presently finding the treasure 200, 210 to accordingly verify the identity and/or emotional state of the winning player. The machine learning module 330 may output a probability of whether the winning player is the same individual who initially signed up and played the game.

The machine learning module 330 may also calculate a virtual path and timeline to the treasure 200, 210 from a prior location of the player and subsequently compare the calculated virtual path to the real world path and timeline of the winning player in order to determine the legitimate win probability. For example, if the player used multiple range finders 912 and found the treasure within less than a minute, then the machine learning module 330 may output a low probability of a legitimate win.

Furthermore, the machine learning module 330 may also calculate a likelihood of possible winners based on their actions and last known locations in the virtual world and subsequently determine the legitimate win probability based on this hierarchy of players who were likely to win. For example, if one of these ten players found the treasure 200, 210 then the machine learning module 330 may output a high probability of a legitimate win. However, if the winning player had an initial probability of winning that was lower than each of the top ten players, then the machine learning module 330 may output a low likelihood of a legitimate win.

Thereby, the machine learning module 330 may conduct primary, secondary, and tertiary calculations to generate the legitimate win probability. If the probability of a legitimate win is low, the machine learning module 330 may flag this situation for review by a game operator. The game operator may subsequently initiate an appropriate review procedure.

The method 1300 may also include sending, by the game server 300, a lockout or kill signal calculated by the processing unit 320 and/or the processing unit 420 to take a particular treasure 200, 210 offline after it has been found. Therein, the lockout signal will prevent a particular treasure 200, 210 from being found by subsequent players. The lockout signal can be sent to the multimedia server 400 and/or the devices 110 of the players.

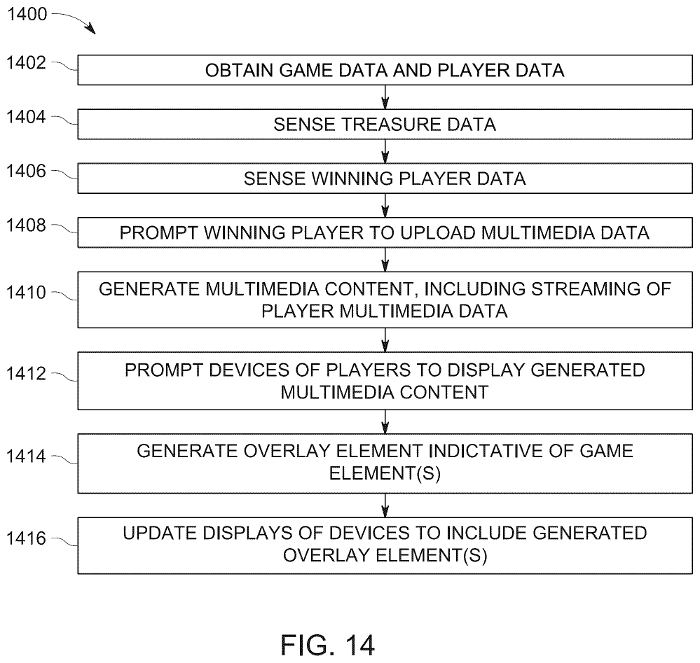

Referring now to FIG. 14, there is shown a flowchart for a method 1400 for generating overlay elements 120 to include in multimedia content 130 being displayed by the displays 111 of player devices 110 (FIG. 2). The game server 300 can generate overlay elements 120 to display in conjunction with player content, or advertising content, to thereby help promote user engagement and boost the view count of certain players who create multimedia content. For example, the players who have won multiple games or accomplished certain achievements may be awarded by the game server 300 and/or multimedia server 400 including additional in-game elements in their multimedia content.

At step 1402, the servers 300, 400 may obtain game data and player data. At step 1404, the game server may sense treasure data. At step 1406, the game server 300 may sense winning player data. At step 1408, the game server 300 may prompt the player to upload multimedia data to the multimedia server 400. Such multimedia data may include finding the treasure and the player's reaction after finding the treasure. Such multimedia data may also include any desired multimedia content which the player wishes to upload.

At step 1410, the multimedia server 400 may generate multimedia content related to the winning player or group of players. The generated multimedia content may include a compilation video, a player video, and/or a live stream of the winning player.

At step 1412, the multimedia server 400 can prompt the devices 110 of the other players to display the generated multimedia content. Therein, it is possible that the other players may stream the multimedia content and watch the finding of a treasure 200, 210 in real time.

At step 1414, the multimedia server 400 may generate one or more overlay elements 120 that are indicative of one or more game elements. The multimedia server 400 may generate the overlay elements 120 based on player data, game data, and sensed treasure data. For example, the multimedia server 400 may generate an overlay element 120 that corresponds to a clue or advantage element for another unfound treasure 200, 210 that is in the same or neighboring region to the recently found treasure 200, 210.

At step 1416, the multimedia server may update the displays 111 of the devices 110 to include the generated overlay element(s) 120. These game elements included in the overlay elements may only be displayed in the generated multimedia content for a limited time. Thereby, if a particular player is watching a video from the multimedia server 400 or advertising partner server 500, the multimedia server 400 generate and display a unique and one-time only overlay element to assist the player in finding a remaining, unfound treasure 200, 210.

The steps of the methods can be performed in any desired order. The steps of the methods can be performed by executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. The method can be performed by one or more processors, a controller, and/or any other desired processing device. The term “software code” used herein refers to any instructions or set of instructions that influence the operation of a computer or controller. Such software code may exist in a computer-executable form, such as machine code, which is the set of instructions and data directly executed by a computer's central processing unit or by a controller, a human-understandable form, such as source code, script, etc., which may be compiled in order to be executed by a processing unit, a controller, or an intermediate form, such as object code, which is produced by a compiler. Furthermore, the software may include, in non-limiting examples, routines, programs, objects, components, and data structures that perform particular tasks or implement particular data types. The server processes may be implemented using a single server or multiple servers working in combination with one another. The server(s), database(s), and software application(s) may be implemented on a single system or distributed across multiple systems.

Other embodiments, which differ from the aforementioned embodiments, may be recognized by those skilled in the art without departing from the scope of the following claims.

1. A method for playing a location-based game comprising:
hiding at least one treasure in the real world;
hosting, by a game server, a virtual and real world treasure hunting game wherein players hunt for the at least one treasure in the real world;
generating, by the game server, an in-game solvable element that is solvable by the players and which aids the players in finding the at least one treasure upon being solved;
integrating the at least one treasure and/or the solvable element with content and/or a location associated with an advertising partner for directly engaging the players with the advertising partner without interrupting a gaming experience;
prompting, by the game server, at least one device of each player to display the solvable element; and
finding, by a winning player of the players, the at least one treasure.

2. A computer-implemented method comprising:
hosting a virtual and real world treasure hunting game wherein players hunt for at least one treasure in the real world;
obtaining player data from at least one sensor of at least one device of each player;
generating a virtual map of the treasure hunting game which corresponds to the real world;
generating an in-game solvable element that is solvable by the players and which aids the players in finding the at least one treasure upon being solved;
generating an in-game advantage element that aids the players in finding the at least one treasure;
integrating the at least one treasure, the solvable element, and/or the advantage element with content and/or a location associated with an advertising partner for directly engaging the players with the advertising partner without interrupting a gaming experience;
prompting an interface of the at least one device of each player to display the solvable element and/or the advantage element;
monitoring the at least one treasure to obtain treasure data from one or more treasure sensors;
obtaining winning player data associated with a winning player of the players who found the at least one treasure; and
validating a legitimate finding of the at least one treasure by the winning player by processing and analyzing the player data, the winning player data, and the treasure data.

3. The method of claim 2, wherein:
the solvable element is generated at least in part upon a hiding location of the at least one treasure and the player data.

4. The method of claim 2, wherein:
the advantage element is unique to each player, and the advantage element is generated at least in part upon a perimeter from a hiding location of the at least one treasure and a physical location of each player in the real world.

5. The method of claim 4, wherein generating the advantage element comprises:
generating a first perimeter from the hiding location of the at least one treasure which defines a blackout zone;
generating a second perimeter from the hiding location of the at least one treasure which defines a working zone, the working zone being greater in size than the blackout zone;
rendering the advantage element operable for a respective player of the players upon sensing the respective player is in the working zone; and
rendering the advantage element inoperable for the respective player upon sensing the respective player is in the blackout zone.

6. The method of claim 2, further comprising:
obtaining player uploaded multimedia data from a multimedia server; and
generating multimedia content associated with the players playing the treasure hunting game.

7. The method of claim 6, further comprising:
prompting the at least one device of each player to display the multimedia content;
generating an overlay element indictive of the solvable element and/or the advantage element based on player data; and
updating a display of the at least one device of each player to include the overlay element.

8. The method of claim 2, wherein the treasure data comprises:
visual data from a sensor monitoring the at least one treasure, at least one treasure housing which houses the at least one treasure therein, and/or a surrounding area thereof;
location data from a sensor of the at least one treasure;
location data from a sensor of the at least one treasure housing; and/or
identifying data from an identifying feature of the at least one treasure.

9. The method of claim 2, wherein:
validating the legitimate finding comprises processing winning player data, which includes visual data of the winning player whilst the winning player is presently finding the at least one treasure, to verify an identity and/or an emotional state of the winning player.

10. A system comprising:
a game server;
one or more processors; and
one or more memories storing executable instructions, wherein the one or more processors are configured to execute the instructions to perform operations comprising:
hosting, by the game server, a virtual and real world treasure hunting game wherein players hunt for at least one treasure in the real world;
obtaining player data from at least one sensor of at least one device of each player;
generating a virtual map of the treasure hunting game which corresponds to the real world;
generating an in-game solvable element that is solvable by the players and which aids the players in finding the at least one treasure upon being solved;
generating an in-game advantage element that aids the players in finding the at least one treasure;
integrating the at least one treasure, the solvable element, and/or the advantage element with content and/or a location associated with an advertising partner for directly engaging the players with the advertising partner without interrupting a gaming experience;
prompting an interface of the at least one device of each player to display the solvable element and/or the advantage element;
monitoring the at least one treasure to obtain treasure data from one or more treasure sensors;
obtaining winning player data associated with a winning player of the players who found the at least one treasure; and
validating a legitimate finding of the at least one treasure by the winning player by processing and analyzing the player data, the winning player data, and the treasure data.

11. The system of claim 10, wherein:
the solvable element is generated at least in part upon a hiding location of the at least one treasure and the player data.

12. The system of claim 10, wherein:
the advantage element is unique to each player, and the advantage element is generated at least in part upon a perimeter from a hiding location of the at least one treasure and a physical location of each player in the real world.

13. The system of claim 12, wherein generating the advantage element comprises:
generating a first perimeter from the hiding location of the at least one treasure which defines a blackout zone;
generating a second perimeter from the hiding location of the at least one treasure which defines a working zone, the working zone being greater in size than the blackout zone;
rendering the advantage element operable for a respective player of the players upon sensing the respective player is in the working zone; and
rendering the advantage element inoperable for the respective player upon sensing the respective player is in the blackout zone.

14. The system of claim 10, wherein the operations further comprise:
obtaining player uploaded multimedia data from a multimedia server; and
generating multimedia content associated with the players playing the treasure hunting game.

15. The system of claim 14, wherein the operations further comprise:
prompting the at least one device of each player to display the multimedia content;
generating an overlay element indictive of the solvable element and/or the advantage element based on player data; and
updating a display of the at least one device of each player to include the overlay element.

16. The system of claim 10, wherein the treasure data comprises:
visual data from a sensor monitoring the at least one treasure, at least one treasure housing which houses the at least one treasure therein, and/or a surrounding area thereof;
location data from a sensor of the at least one treasure;
location data from a sensor of the at least one treasure housing; and/or
identifying data from an identifying feature of the at least one treasure.

17. A non-transitory computer-readable storage medium storing executable instructions that, when executed by one or more processors, cause operations comprising:
hosting a virtual and real world treasure hunting game wherein players hunt for at least one treasure in the real world;
obtaining player data from at least one sensor of at least one device of each player;
generating a virtual map of the treasure hunting game which corresponds to the real world;
generating an in-game solvable element that is solvable by the players and which aids the players in finding the at least one treasure upon being solved;
generating an in-game advantage element that aids the players in finding the at least one treasure;
integrating the at least one treasure, the solvable element, and/or the advantage element with content and/or a location associated with an advertising partner for directly engaging the players with the advertising partner without interrupting a gaming experience;
prompting an interface of the at least one device of each player to display the solvable element and/or the advantage element;
monitoring the at least one treasure to obtain treasure data from one or more treasure sensors;
obtaining winning player data associated with a winning player of the players who found the at least one treasure; and
validating a legitimate finding of the at least one treasure by the winning player by processing and analyzing the player data, the winning player data, and the treasure data.

18. The storage medium of claim 17, wherein:
the operations further comprise obtaining player uploaded content from a multimedia server and generating multimedia content associated with the players playing the treasure hunting game.

19. The storage medium of claim 17, wherein:
the solvable element is generated at least in part upon a hiding location of the at least one treasure and the player data.

20. The storage medium of claim 17, wherein:
the advantage element is unique to each player, and the advantage element is generated at least in part upon a perimeter from a hiding location of the at least one treasure and a physical location of each player in the real world.
